(19) United States
(12) Patent Application Publication
(10) Pub. No.: US 2025/0337705 A1
(43) Pub. Date: Oct. 30, 2025

(54) METHOD, APPARATUS, DEVICE, AND STORAGE MEDIUM FOR DISPLAYING A SESSION

(71) Applicant: Beijing Zitiao Network Technology Co., Ltd., Haidian District, Beijing (CN)

(72) Inventors: Jiahui Yang, Beijing (CN); Xiaoxue Zhang, Beijing (CN)

(21) Appl. No.: 19/192,659

(22) Filed: Apr. 29, 2025

Related U.S. Application Data
(63) Continuation of application No. PCT/CN2024/089910, filed on Apr. 25, 2024.

(51) Int. Cl. H04L 51/046

(52) U.S. Cl. CPC H04L 51/046

(57) ABSTRACT

Embodiments of the disclosure relate to a method, an apparatus, a device and a storage medium for displaying a session. The method proposed herein includes: presenting a first interface associated with a first account in a first application by accessing a first data set associated with the first application, the first interface presenting a first group of sessions in which the first account participates in the first application, the first interface further providing a message viewing entry associated with a second application; and presenting, in the first application, a second interface associated with a second account in the second application by accessing a second data set associated with the second application in response to a selection of the message viewing entry, the second account associated with the first account, the second interface presenting a second group of sessions in which the second account participates in the second application.

### CROSS-REFERENCE

This application claims the benefit of International Patent Application No. PCT/CN2024/089910 filed on Apr. 25, 2024, entitled “METHOD, APPARATUS, DEVICE AND STORAGE MEDIUM FOR DISPLAYING A SESSION”, which is hereby incorporated by reference in its entirety.

### FIELD

Example embodiments of the present disclosure generally relate to the field of computers, and more particularly, to a method, an apparatus, a device, and a computer-readable storage medium for displaying a session.

### BACKGROUND

In recent years, with development of the Internet, people may conduct network activities across a plurality of application platforms. However, currently, since application platforms are independent from each other, in a process of using one application platform, a user can obtain and reply to a message of another application platform only by switching to another application platform, which cannot meet a demand of people for processing information quickly.

### SUMMARY

In a first aspect of the present disclosure, a method for displaying a session is provided. The method includes: presenting a first interface associated with a first account in a first application by accessing a first data set associated with the first application, the first interface presenting a first group of sessions in which the first account participates in the first application, the first interface further providing a message viewing entry associated with a second application; and presenting, in the first application, a second interface associated with a second account in the second application by accessing a second data set associated with the second application in response to a selection of the message viewing entry, the second account associated with the first account, the second interface presenting a second group of sessions in which the second account participates in the second application.

In a second aspect of the present disclosure, an apparatus for displaying a session is provided, the apparatus includes a first presenting module configured to present a first interface associated with a first account in a first application by accessing a first data set associated with the first application, the first interface presenting a first group of sessions in which the first account participates in the first application, the first interface further providing a message viewing entry associated with a second application; and a second presenting module configured to present, in the first application, a second interface associated with a second account in the second application by accessing a second data set associated with the second application in response to a selection of the message viewing entry, the second account associated with the first account, the second interface presenting a second group of sessions in which the second account participates in the second application.

In a third aspect of the present disclosure, an electronic device is provided, the device including at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer readable storage medium is provided, where the computer readable storage medium stores a computer program thereon, and the computer program is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference signs denote the same or similar elements, where:

FIG. 1 illustrates a schematic diagram of an example environment in which the embodiments according to the present disclosure may be implemented in real time;

FIGS. 2A-2D illustrate example interfaces according to some embodiments of the present disclosure;

FIG. 3 illustrates a flowchart of an example process for displaying a session according to some embodiments of the present disclosure;

FIG. 4 illustrates a schematic structural block diagram of an example apparatus for displaying a session according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

The embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

In the technical solution in this description and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned briefly above, with the development of the Internet, people may conduct network activities across multiple application platforms. However, currently, since application platforms are independent from each other, in a process of using one application platform, a user can obtain and reply to a message of another application platform only by switching to the another application platform, messages between different application platforms cannot be intercommunicated, which cannot meet a requirement of people for quickly obtaining information, resulting in low efficiency of people in processing information.

Embodiments of the present disclosure provide a solution for displaying a session. According to the solution, a first interface associated with a first account in a first application can be presented by accessing a first data set associated with the first application, the first interface presenting a first group of sessions in the first application in which the first account participates, and the first interface further providing a message viewing entry associated with a second application; and in response to a selection of the message viewing entry, a second interface associated with a second account in the second application is presented in the first application by accessing a second data set associated with the second application, the second account associated with the first account, the second interface presenting a second group of sessions in the second application in which the second account participates.

In this way, the embodiments of the present disclosure can provide a message viewing entry of a second application in a first application through which a user can view a message session associated with the second application in the first application. Thus, the embodiments of the present disclosure can mutually call data between different applications, thus realizing message intercommunication between different applications, and further improving the resource utilization rate, which enable people to process information between a plurality of different application platforms on one application platform, and improve the efficiency of people in processing information.

Various example implementations of the solution are described in further detail below with reference to the accompanying drawings.

### Example Environment

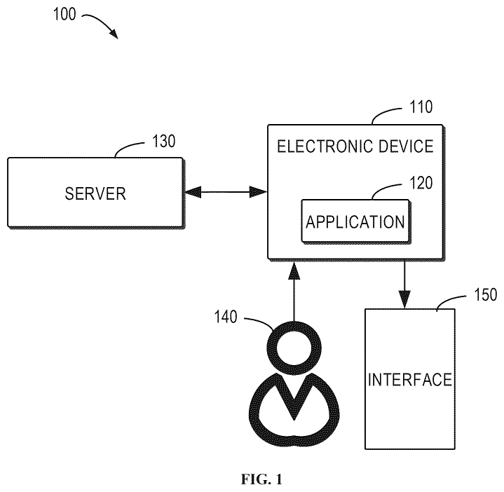

FIG. 1 illustrates a schematic diagram of an example environment 100 in which embodiments of the present disclosure can be implemented. As shown in FIG. 1, example environment 100 may include an electronic device 110.

In this example environment 100, an application 120 that supports interface interaction may run on an electronic device 110. The application 120 may be any suitable type of application for interface interaction, examples of which may include but are not limited to: a video application, a social application, or other appropriate applications. A user 140 may interact with application 120 via the electronic device 110 and/or its attached devices.

In the environment 100 of FIG. 1, if the application 120 is in an active state, the electronic device 110 may present an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenarios.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interactions

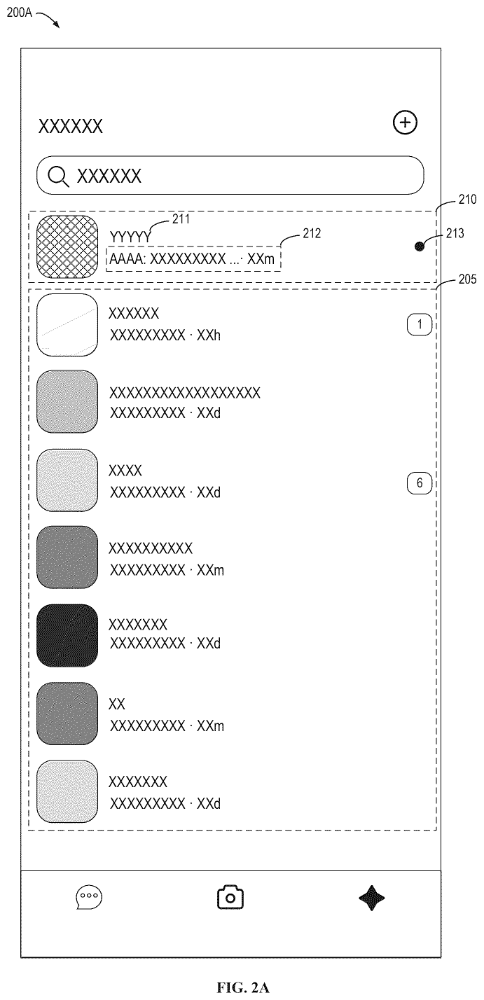

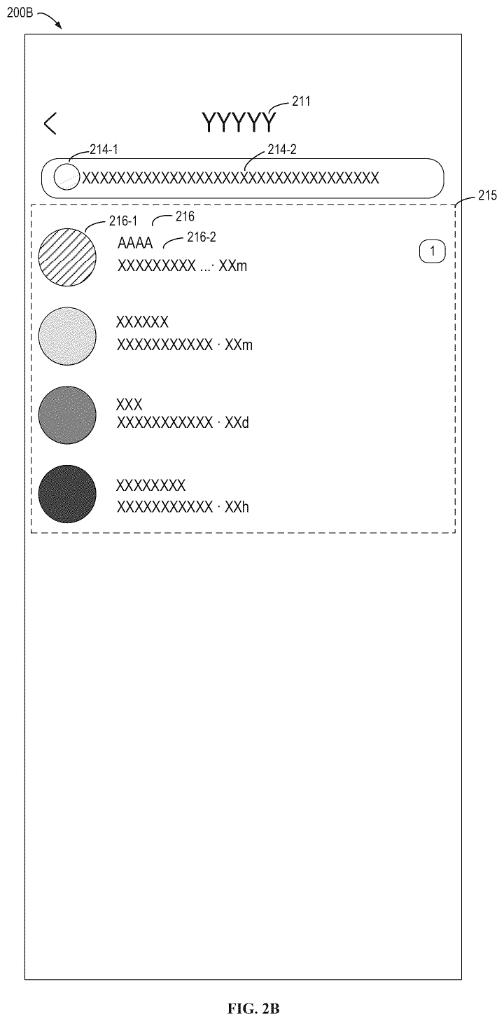

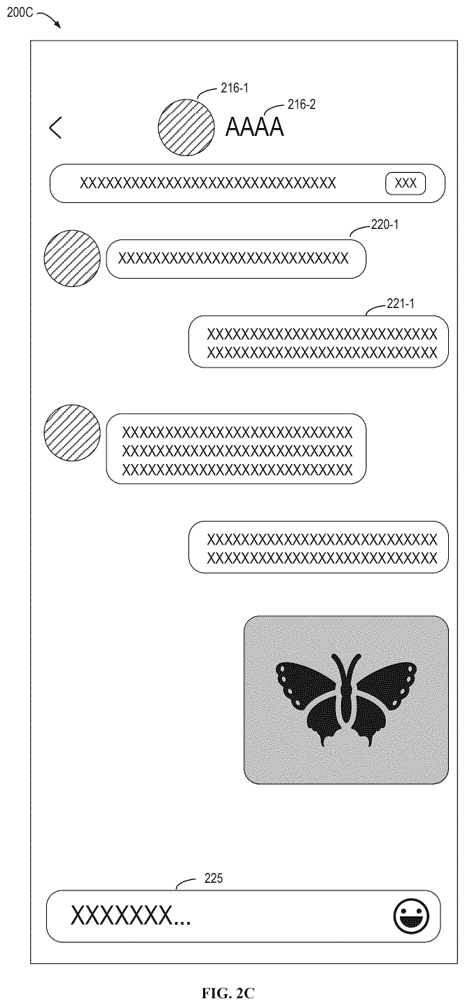

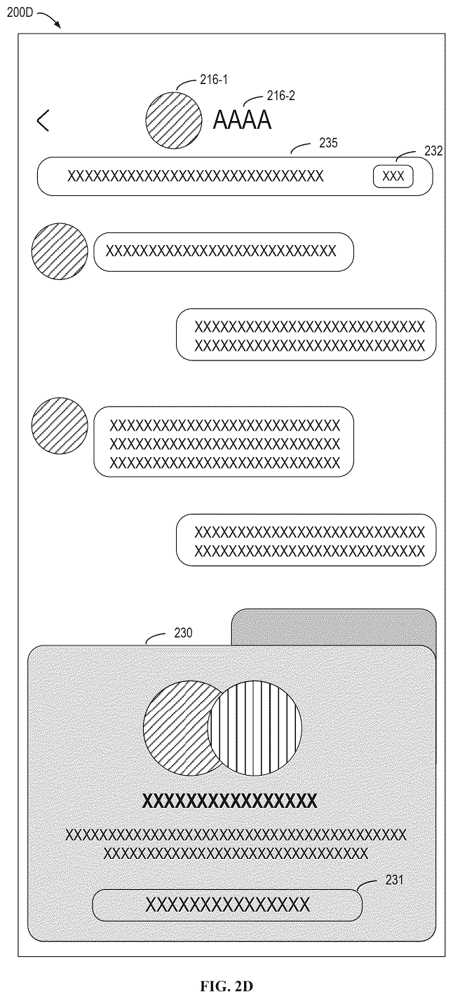

FIGS. 2A-2D illustrate example interfaces 200A-200D according to some embodiments of the disclosure. The interfaces 200A-200D may be provided, for example, by the electronic device 110 shown in FIG. 1.

In some embodiments, the electronic device 110 may present a first interface 200A associated with a first account of a first application, as shown in FIG. 2A, by accessing a first data set associated with the first application. The first interface 200A may present a first group of sessions in which the first account participates in the first application. As an example, the first data set may include first session message content associated with the first group of sessions of the first account. The first session message content may include session messages of the first user with other users in the first application and application messages from the first application.

In some embodiments, with reference to FIG. 2A, the electronic device 110 also provides a message viewing entry 210 associated with the second application in the first interface 200A. As an example, the second application is different from the first application, e. g., the first application may be application A and the second application may be application B. As an example, the message viewing entry 210 may display a second application identifier 211 (e. g., YYYYY).

In some embodiments, with continued reference to FIG. 2A, the electronic device 110 may also present prompt identifier 213 in message viewing entry 210 of the first interface 200A in response to receiving a message associated with the second application. The prompt identifier 213 may indicate that there is an unread message associated with the second application. Setting the prompt identifier 213 may remind the user that there is an unread message associated with the second application, thereby improving the efficiency of the user in processing information.

In some embodiments, as shown in FIG. 2A, the electronic device 110 may also present the first message 211 received by the second account from the second application in the message viewing entry 210 by accessing the second data set. As an example, the first message 211 receives the latest message by the second account received from the second application. The second account is an account associated with the second application. The second account is different from the first account.

In some embodiments, the electronic device 110 may present, in the first application, a second interface associated with a second account in the second application by accessing a second data set associated with the second application in response to a selection of the message viewing entry 210. The second interface presents a second group of sessions in which the second account participates in the second application. As an example, the second data set may include second session message content associated with the second group of sessions of the second account. The second session message content may include session messages of the second user with other users in the second application and application messages from the second application.

In some embodiments, as shown in FIG. 2B, the electronic device 110 may, in the first application, present a second interface 200B associated with a second account in the second application in response to the selection of the message viewing entry 210. The electronic device 110 may present, in second interface 200B, the second group of sessions 215 in which the second account participates in the second application.

In some embodiments, the first account is associated with the second account in the second application based on at least one item of reference information of the target user.

In some embodiments, the at least one piece of reference information may be that the first account has a binding relationship with the second account.

In some embodiments, the at least one piece of reference information may be both the first account and the second account are generated based on the same target account (e. g., an email address, a mobile phone number, etc.), and there is no binding relationship therebetween. In this manner, an account (e. g., a first account in a first application) in one application may receive messages from an account (e. g., a second account of a second application) created in a different application based on the same target account.

In some embodiments, the electronic device 110 may further present description information in the second interface 200B, and the description information may include an application identifier of the second application, a text identifier of the second account, and/or an image identifier of the second account. As an example, as shown in FIG. 2B, the electronic device 110 may present, in second interface 200B, an application identifier 211 of the second application, an image identifier 214-1 of the second account, and text identifier 214-2.

In some embodiments, the electronic device 110 may associate with the second group of sessions in the second interface by accessing the second data set, and present a group of session identifiers corresponding to the second group of sessions, the group of session identifiers include image identifiers and/or text identifiers. The second group of sessions includes a plurality of second sessions, and the electronic device 110 may present image identifiers and/or text identifiers corresponding to each second session. As an example, as shown in FIG. 2B, the electronic device 110 may present, e. g., in second interface 200B, an image identifier 216-1 and a text identifier 216-2 corresponding to the second session 216. The image identifier 216-1 may indicate an avatar of a third account in the second application that initiated the session with the second account. The text identifier 216-2 may indicate an identifier (e. g., a nickname, a remark name, etc.) of a third account in the second application that initiates a session with a second account and all or part of session content of the second session 216 (only part of the session content is displayed when the session content exceeds a certain number of words) and time information of the second session.

In some embodiments, the electronic device 110 may present a session interface corresponding to the target session in response to the selection of the target session in the second group of sessions, the session interface presenting at least one message in the target session.

In some embodiments, the electronic device 110 may present, in second interface 200B, the session interface 200C (as shown in FIG. 2C) that corresponds to the target session in response to a selection of a target session (e. g., second session 216) in the second group of sessions, and the session interface 200C presents at least one message 220-1 in the target session. As an example, the electronic device 110 may further present, in session interface 200, the image identifier 216-1 and the text identifier 216-2 corresponding to the second session 216C.

In some embodiments, with reference to FIG. 2C, the electronic device 110 may, in response to receiving a target message in session interface 200C, trigger the second application to send the target message to the target session, and present the target message in session interface 200C. For example, as shown in FIG. 2C, the electronic device 110 may provide an input control 225 in session interface 200C. Further, the electronic device 110 may receive a target message 221-1 input by a user from the input control 225, trigger the second application to send the target message 221-1 to a target session (e. g., second session 216), and present the target message 221-1 in the session interface 200C.

In some embodiments, the electronic device 110 may, in response to the second message in the target session of a predetermined first type, convert the second message into a second type that is adapted to the first application, to be presented in the session interface. As an example, the predetermined first type may include an action type, a picture type, a video type, and/or a link type, and the second message corresponding to the predetermined first type (for example, a link type) is converted into a second type adapted to the first application (for example, prompting content, for example, XXX sends a link). By converting a second message of the predetermined first type into a second type adapted to a first application, compatibility of message display between different applications is improved, and user experience and message processing efficiency are improved.

In some embodiments, the target session is associated with a third account in the second application, the third account associated with a fourth account in the first application. As an example, the third account is an account in the second application different from the second account, and the fourth account is an account in the first application different from the first account. The first account of the first application may be associated with a second account of the second application and the fourth account of the first application may be associated with a third account of the second application.

In some embodiments, the electronic device 110 may call the second data set to determine that the second account and the third account satisfy a first predetermined relationship in the second application (for example, the second account and the third account follow each other or have a friend relationship, etc.). In response to the first account and the fourth account not satisfying the second predetermined relationship in the first application (e. g., not having a following relationship or a friend relationship), the electronic device 110 provides the prompt information in the session interface 200C.

In some embodiments, and with reference to FIG. 2D, the electronic device 110 may present prompt information 230 in the session interface 200D, and the prompt information may include an interaction entry 231, first description content associated with the first account, and/or second description content associated with the fourth account. Further, the electronic device 110 may send a request for establishing a predetermined relationship between the first account and the fourth account to the fourth account in response to a trigger to the interaction entry 231.

In some embodiments, the first description content may be a first image identifier and/or account introduction of the first account in the first application and the second description content may be a first image identifier and/or account introduction of the fourth account in the first application.

In some embodiments, with continued reference to FIG. 2D, the electronic device 110 can further present a prompt control 235 on top of session interface 200D, and the prompt control may include a second interaction entry 232 and prompt content regarding the first account and the fourth account not satisfying the predetermined relationship. Further, the electronic device 110 may send to the fourth account a request for establishing a predetermined relationship between the first account and the fourth account in response to the triggering of the second interaction entry 232. By means of the method, a user can be assisted to establish a corresponding relationship in other applications based on an existing application relationship with a target user, which is conducive to improving the user's social experience and facilitating the exchange and communication between users.

Based on the processes described above, the embodiments of the present disclosure can mutually call data between different applications, Therefore, information can be transferred between different applications, and the resource utilization rate can be further improved, so that people can process information between a plurality of different application platforms in one application platform, thus the problem of untimely message acquisition or reply caused after a user switches applications is avoided, and the efficiency of people in processing information is improved.

### Example Processes

FIG. 3 illustrates a flowchart of an example process 300 for displaying a session according to some embodiments of the disclosure. The process 300 may be implemented at electronic device 110. The process 300 is described below with reference to FIG. 1.

As shown, at block 310, the electronic device 110 presents a first interface associated with a first account in a first application by accessing a first data set associated with the first application, the first interface presenting a first group of sessions in which the first account participates in the first application, the first interface further providing a message viewing entry associated with a second application.

At block 320, in response to the selection of the message viewing entry, a second interface associated with a second account in a second application is presented in the first application by accessing a second data set associated with the second application, the second account associated with the first account, the second interface presenting a second group of sessions in which the second account participates in the second application.

In some embodiments, the method 300 further includes presenting, in the message viewing entry, a first message received by the second account in the second application by accessing the second data set.

In some embodiments, the method 300 further includes presenting description information in the second interface, the description information including at least one of the following: an application identifier of the second application, a text identifier of the second account, or an image identifier of the second account.

In some embodiments, the method 300 further includes presenting, in the second interface, a group of session identifiers corresponding to the second group of sessions in association with the second group of sessions by accessing the second data set, the group of session identifiers including image identifiers and/or text identifiers.

In some embodiments, the method 300 further includes: in response to a selection of a target session in a second group of sessions, presenting a session interface corresponding to the target session, the session interface presenting at least one message in the target session; in response to receiving a target message in the session interface, triggering the second application to send the target message to the target session; and presenting the target message in the session interface.

In some embodiments, the method 300 further includes, in response to a second message in the target session being of a predetermined first type, converting the second message into a second type adapted to the first application, to be presented in the session interface.

In some embodiments, the target session is associated with a third account in the second application, and the third account is associated with a fourth account in the first application. The method 300 further includes: determining, by accessing the second data set, that the second account and the third account satisfy a first predetermined relationship in the second application; and in response to the first account and the fourth account not satisfying a second predetermined relationship in the first application, providing prompt information in the session interface.

In some embodiments, the prompt information includes: an interaction entry for triggering the first account and the fourth account to satisfy the second predetermined relationship; first description content associated with the first account; and second description content associated with the fourth account.

In some embodiments, the first description content includes a first image identifier of the first account in the first application; and/or the second description content includes a second image identifier of the fourth account in the first application.

In some embodiments, the first account is associated with the second account in the second application based on at least one piece of reference information of a target user.

### Example Apparatus and Device

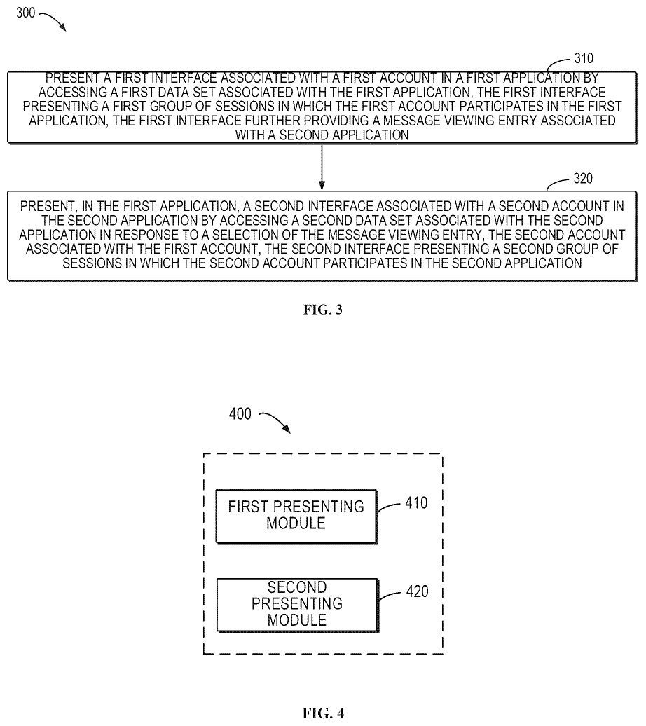

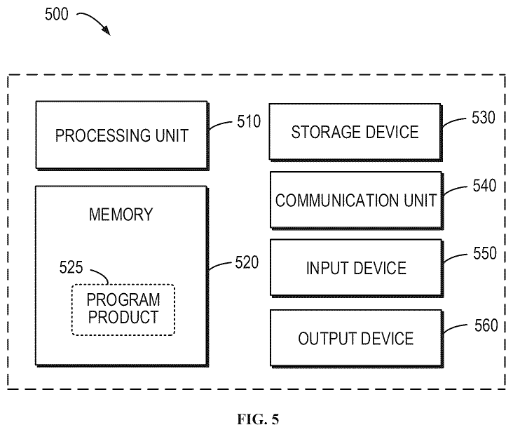

Embodiments of the present disclosure further provide a corresponding apparatus for implementing the methods or processes described above. FIG. 4 illustrates a schematic structural block diagram of an example apparatus 400 for displaying a session according to certain embodiments of the present disclosure. The apparatus 400 may be implemented as or included in an electronic device. The various modules/components in the apparatus 400 may be implemented by hardware, software, firmware, or any combination thereof.

As shown in FIG. 4, the apparatus 400 includes a first presenting module 410 configured to present a first interface associated with a first account in a first application by accessing a first data set associated with the first application, the first interface presenting a first group of sessions in the first application in which the first account participates, the first interface further providing a message viewing entry associated with a second application; and a second presenting module 420 configured to present, in the first application, a second interface associated with a second account in the second application by accessing a second data set associated with the second application in response to a selection of the message viewing entry, the second account associated with the first account, the second interface presenting a second group of sessions in the second application in which the second account participates.

In some embodiments, the first presenting module 410 is further configured to present, in the message viewing entry, a first message received by the second account in the second application by accessing the second data set.

In some embodiments, the second presenting module 420 is further configured to present description information in the second interface, the description information including at least one of the following: an application identifier of the second application, a text identifier of the second account, or an image identifier of the second account.

In some embodiments, the second presenting module 420 is further configured to present, in the second interface, a group of session identifiers corresponding to the second group of sessions in association with the second group of sessions by accessing the second data set, the group of session identifiers including image identifiers and/or text identifiers.

In some embodiments, the apparatus 400 further includes a session module configured to: present a session interface corresponding to a target session in the second group of sessions in response to a selection of the target session, the session interface presenting at least one message in the target session; in response to receiving a target message in the session interface, trigger the second application to send the target message to the target session; and present the target message in the session interface.

In some embodiments, the session module is further configured to convert, in response to a second message in the target session being of a predetermined first type, the second message into a second type adapted to the first application, to be presented in the session interface.

In some embodiments, the session module is further configured to: the target session is associated with a third account in the second application, the third account is associated with a fourth account in the first application; determine, by accessing the second data set, that the second account and the third account satisfy a first predetermined relationship in the second application; in response to the first account and the fourth account not satisfying a second predetermined relationship in the first application, provide prompt information in the session interface.

In some embodiments, the session module is further configured to: an interaction entry for triggering the first account and the fourth account to satisfy the second predetermined relationship; first description content associated with the first account; and second description content associated with a fourth account.

In some embodiments, the session module is further configured to: the first description content includes a first image identification of the first account in the first application; and/or the second description content includes a second image identifier of the fourth account in the first application.

In some embodiments, the apparatus 400 further includes a processing module configured to: associate the first account with a second account in the second application based on at least one piece of reference information of a target user.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 can be used in an electronic device.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for displaying a session, comprising:
presenting a first interface associated with a first account in a first application by accessing a first data set associated with the first application, the first interface presenting a first group of sessions in which the first account participates in the first application, the first interface further providing a message viewing entry associated with a second application; and
presenting, in the first application, a second interface associated with a second account in the second application by accessing a second data set associated with the second application in response to a selection of the message viewing entry, the second account associated with the first account, the second interface presenting a second group of sessions in which the second account participates in the second application.

2. The method of claim 1, further comprising:
presenting, in the message viewing entry, a first message received by the second account in the second application by accessing the second data set.

3. The method of claim 1, further comprising:
presenting description information in the second interface, the description information comprising at least one of the following: an application identifier of the second application, a text identifier of the second account, or an image identifier of the second account.

4. The method of claim 1, further comprising:
presenting, in the second interface, a group of session identifiers corresponding to the second group of sessions in association with the second group of sessions by accessing the second data set, the group of session identifiers comprising image identifiers and/or text identifiers.

5. The method of claim 1, further comprising:
presenting a session interface corresponding to a target session in the second group of sessions in response to a selection of the target session, the session interface presenting at least one message in the target session;
in response to receiving a target message in the session interface, triggering the second application to send the target message to the target session; and
presenting the target message in the session interface.

6. The method of claim 5, further comprising:
in response to a second message in the target session being of a predetermined first type, converting the second message into a second type adapted to the first application, to be presented in the session interface.

7. The method of claim 5, wherein the target session is associated with a third account in the second application, and the third account is associated with a fourth account in the first application, the method further comprising:
determining, by accessing the second data set, that the second account and the third account satisfy a first predetermined relationship in the second application; and
in response to the first account and the fourth account not satisfying a second predetermined relationship in the first application, providing prompt information in the session interface.

8. The method of claim 7, wherein the prompt information comprises:
an interaction entry for triggering the first account and the fourth account to satisfy the second predetermined relationship;
first description content associated with the first account; and
second description content associated with the fourth account.

9. The method of claim 8, wherein the first description content comprises a first image identifier of the first account in the first application; and/or the second description content comprises a second image identifier of the fourth account in the first application.

10. The method of claim 1, wherein the first account is associated with the second account in the second application based on at least one piece of reference information of a target user.

11. An electronic device, comprising:
at least one processing unit;
at least one memory coupled to the at least one processing unit and storing instructions for execution by the at least one processing unit, the instructions, when executed by the at least one processing unit, cause the electronic device to perform acts comprising:
presenting a first interface associated with a first account in a first application by accessing a first data set associated with the first application, the first interface presenting a first group of sessions in which the first account participates in the first application, the first interface further providing a message viewing entry associated with a second application; and
presenting, in the first application, a second interface associated with a second account in the second application by accessing a second data set associated with the second application in response to a selection of the message viewing entry, the second account associated with the first account, the second interface presenting a second group of sessions in which the second account participates in the second application.

12. The electronic device of claim 11, wherein the acts further comprise:
presenting, in the message viewing entry, a first message received by the second account in the second application by accessing the second data set.

13. The electronic device of claim 11, wherein the acts further comprise:
presenting description information in the second interface, the description information comprising at least one of the following: an application identifier of the second application, a text identifier of the second account, or an image identifier of the second account.

14. The electronic device of claim 11, wherein the acts further comprise:
presenting, in the second interface, a group of session identifiers corresponding to the second group of sessions in association with the second group of sessions by accessing the second data set, the group of session identifiers comprising image identifiers and/or text identifiers.

15. The electronic device of claim 11, wherein the acts further comprise:
presenting a session interface corresponding to a target session in the second group of sessions in response to a selection of the target session, the session interface presenting at least one message in the target session;
in response to receiving a target message in the session interface, triggering the second application to send the target message to the target session; and
presenting the target message in the session interface.

16. The electronic device of claim 15, wherein the acts further comprise:
in response to a second message in the target session being of a predetermined first type, converting the second message into a second type adapted to the first application, to be presented in the session interface.

17. The electronic device of claim 15, wherein the target session is associated with a third account in the second application, and the third account is associated with a fourth account in the first application, the acts further comprising:
determining, by accessing the second data set, that the second account and the third account satisfy a first predetermined relationship in the second application; and
in response to the first account and the fourth account not satisfying a second predetermined relationship in the first application, providing prompt information in the session interface.

18. The electronic device of claim 17, wherein the prompt information comprises:
an interaction entry for triggering the first account and the fourth account to satisfy the second predetermined relationship;
first description content associated with the first account; and
second description content associated with the fourth account.

19. The electronic device of claim 18, wherein the first description content comprises a first image identifier of the first account in the first application; and/or the second description content comprises a second image identifier of the fourth account in the first application.

20. A non-transitory computer readable storage medium having stored thereon a computer program, the computer program being executable by a processor to implement acts comprising:
presenting a first interface associated with a first account in a first application by accessing a first data set associated with the first application, the first interface presenting a first group of sessions in which the first account participates in the first application, the first interface further providing a message viewing entry associated with a second application; and
presenting, in the first application, a second interface associated with a second account in the second application by accessing a second data set associated with the second application in response to a selection of the message viewing entry, the second account associated with the first account, the second interface presenting a second group of sessions in which the second account participates in the second application.
